(19) United States
(12) Patent Application Publication
(10) Pub. No.: US 2025/0296157 A1
(43) Pub. Date: Sep. 25, 2025

(54) MILLING DEVICE FOR GRINDING EJECTOR PIN MACHINE

(71) Applicant: VERO VERIA CORPORATION, Taipei (TW)

(72) Inventors: CHIEN-TEH HUANG, Taipei (TW); SHAN-HANG CHEN, Taipei (TW)

(21) Appl. No.: 18/814,721

(22) Filed: Aug. 26, 2024

(30) Foreign Application Priority Data
Mar. 22, 2024 (TW) 113110668

(51) Int. Cl. B23C 1/06

(52) U.S. Cl. CPC B23C 1/06; B23C 2255/00

(57) ABSTRACT

A milling device for a grinding ejector pin machine provided by the present invention has a cutter seat, a sleeve, a milling cutter, and a pedestal. The cutter seat has a push rod and a spindle, wherein the push rod has a first accommodating space, and the spindle is located in the first accommodating space. The sleeve is hollow and located at one end of the cutter seat. The milling cutter is connected to the spindle and located in the sleeve. The pedestal has a collar, a stroke adjustment device and a ball mill head, the collar accommodates partial of the push rod, and the stroke adjustment device is at one end of the collar.

### CROSS-REFERENCE TO RELATED APPLICATIONS

This application claims priority to Taiwan Application Serial Number 113110668, filed Mar. 22, 2024, which is herein incorporated by reference in its entirety.

### BACKGROUND OF THE INVENTION

The present invention relates to a machine for trimming burrs, more particularly to a milling device for a grinding ejector pin machine.

### DESCRIPTION OF THE RELATED ART

For today's high-end sites such as semiconductor factory floors and cleanroom floors, raised floors are being widely applied. In the meantime, the present raised floors are made from aluminum alloy die-casting, which requires five main processes of mold opening, aluminum melting, die casting, molding, and trimming.

During the molding process, the surface and bottom of the raised floor often generate many burrs. These burrs can prevent the raised floors from fitting tightly together and from properly adhering to the platform frames while in installation. On the other hand, the burrs cannot facilitate such installations, and they will have safety concerns for workers and equipment.

Currently, manual methods are used to remove the burrs on the four legs and intersecting ribs of the raised floor after molding. Such way not only results in low production efficiency but also consumes significant labor and time for each processing. Therefore, overcoming these disadvantages of conventional technology has become a pressing challenge for people skilled in the art.

### SUMMARY OF THE INVENTION

The objective of the present invention provides a milling device for a grinding ejector pin machine. By means of arranging the plurality of milling devices into plural groups of milling device matrices in a non-interfering state, and combining with an automatic process, the top needle structures of the raised floors are ground and milled in batches, therefore it speeds up production and improves efficiency, and reduces labor requirements as well.

A milling device for a grinding ejector pin machine provided by the present invention has a cutter seat, a sleeve, a milling cutter, and a pedestal. The cutter seat has a push rod and a spindle, wherein the push rod has a first accommodating space, and the spindle is located in the first accommodating space. The sleeve is hollow and located at one end of the cutter seat. The milling cutter is connected to the spindle and located in the sleeve. The pedestal has a collar, a stroke adjustment device and a ball mill head, the collar accommodates partial of the push rod, and the stroke adjustment device is at one end of the collar.

The stroke adjustment device further comprises a stroke bracket, a damper, a first adjuster, a second adjuster, a first stroke contactor, and a second contactor. The stroke bracket is located at one side of the pedestal and has an abutment surface. The damper is connected to the stroke bracket. The first adjuster is at a first distance from the abutment surface.

The second adjuster is at a second distance from the abutment surface. The first stroke contactor is adjacent to the first adjuster. The milling cutter is in a first position when the first stroke contactor contacts the first adjuster. The second stroke contactor is adjacent to the second adjuster. The milling cutter is in a second position when the second stroke contactor contacts the second adjuster.

For an embodiment, an upper end of the sleeve is internally disposed a drill head fixed plate, the head fixed plate is a hollow structure and located at one end of the sleeve, the drill head fixed plate is connected to a lower end of the push rod.

For an embodiment, two ends of the push rod are a large-diameter section and a small-diameter section respectively, the small-diameter section is neighbor to the pedestal, the push rod is hollow, so that the small-diameter section can be in communication with the first accommodating space.

For an embodiment, an outer edge of the spindle further has a limit device with a bearing, a locking nut, and a handle nut, the bearing is fitted onto the spindle, the locking nut is fixed on the bearing, the handle nut is in the large-diameter section and accommodating the locking nut, the handle nut is screwed into an internal thread of the push rod, in order to let the handle nut be fixed on an outer ring of the bearing.

For an embodiment, the spindle has a second accommodating space that accommodates a spline, one end of the spline has a first texture, the second accommodating space at one end of the spindle has a second texture corresponding to the first texture, through combination of the first texture and the second texture, the spline drives the spindle for rotation movements.

For an embodiment, another end of the spline is connected to a synchronous wheel, the synchronous wheel drives the spline and the spindle for synchronous rotations.

For an embodiment, the stroke adjustment device further has an air inlet valve and an air outlet valve, the air inlet valve provides a gas that enters into the stroke adjustment device in order to let the push rod perform a displacement movement, the air outlet valve allows the gas to move out of the stroke adjustment device, so as to facilitate replacement of the milling cutter.

For an embodiment, the stroke adjustment device further comprises a back pressure exhaust valve, which is at the air inlet flow channel, the incoming gas is ejected via the back pressure exhaust valve when the intake pressure exceeds the back pressure exhaust pressure.

For an embodiment, the sleeve has an internal thread which threads into an external thread on the outer edge of the drill head fixed plate, in order to adjust the relative position between the sleeve and the drill head fixed plate.

For an embodiment, the milling device for the grinding ejector pin machine further comprises a locking bolt, via the locking bolt, the sleeve is fixed on the drill head fixed plate, and the drill head fixed plate is firmly solidified on the push rod, so as to let the sleeve and the push rod move up and down simultaneously.

For an embodiment, the air inlet valve provides the gas that enters the stroke adjustment device from an air inlet flow channel, in order to let the push rod perform a displacement movement.

For an embodiment, the air outlet valve allows the gas to move out of the stroke adjustment device from an air outlet flow channel, so as to facilitate replacement of the milling cutter.

For an embodiment, the sleeve additionally has a screw nut, through a locking bolt, the sleeve is fixed on the drill head fixed plate, and the drill head fixed plate is firmly solidified on the push rod, so as to let the sleeve and the push rod move up and down simultaneously, if the adjustment of height position of the sleeve is finished.

For an embodiment, the milling cutter is firmly locked in a screw hole at a bottom of the spindle via a screw bolt, the milling cutter is disposed in the sleeve.

For an embodiment, the stroke adjustment device is firmly connected to one end of the collar, the ball mill head is fixed at another end of the collar, in order to form an air cylinder.

For an embodiment, the abutment surface is located at one side of the stroke bracket.

For an embodiment, the first texture has plural external slots, and the second texture has plural internal slots corresponding to the first texture, the one end of the spline is inserted into the second accommodating space, by means of the external slots and the internal slots that are corresponding to each other, the spindle is moved up and down linearly.

For an embodiment, the bearing is fitted onto the spindle and the locking nut is fixed on the bearing, that is, the inner ring of the bearing is tightly fitted onto the spindle, and the locking nut being secured onto an outer thread of the spindle to support and fix on the bottom of the inner ring of the bearing, so as to let the locking nut and the bearing rotate together with the spindle.

For an embodiment, the handle nut accommodates the locking nut, the handle nut is screwed into an internal thread of the push rod, in order to let the handle nut be fixed on an outer ring of the bearing, that is, an outer thread of the handle nut is screwed into the internal thread at one end of the push rod, in order to let the handle nut be fixed on a bottom of the outer ring of the bearing.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 illustrates a schematic 3-D view of a first embodiment of the present invention;

FIG. 2 illustrates a schematic 3-D view of a first position of the milling cutter of the first embodiment of the present invention;

FIG. 3 illustrates a schematic 3-D view of a second position of the milling cutter of the first embodiment of the present invention;

FIG. 4 is a schematic view of an AA cross-section of FIG. 1;

FIG. 5 illustrates an enlarged view of a B section of FIG. 4;

FIG. 6 illustrates a schematic rotation movement view of partial components of the first embodiment of the present invention;

FIG. 7 illustrates a schematic rotation movement view of a push rod of the first embodiment of the present invention (part 1);

FIG. 8 illustrates a schematic rotation movement view of the push rod of the first embodiment of the present invention (part 2); and

FIG. 9 illustrates a schematic 3-D view of a second embodiment of the present invention; and

FIG. 10 illustrates a schematic displacement movement view of the push rod of a CC cross-section of FIG. 9.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

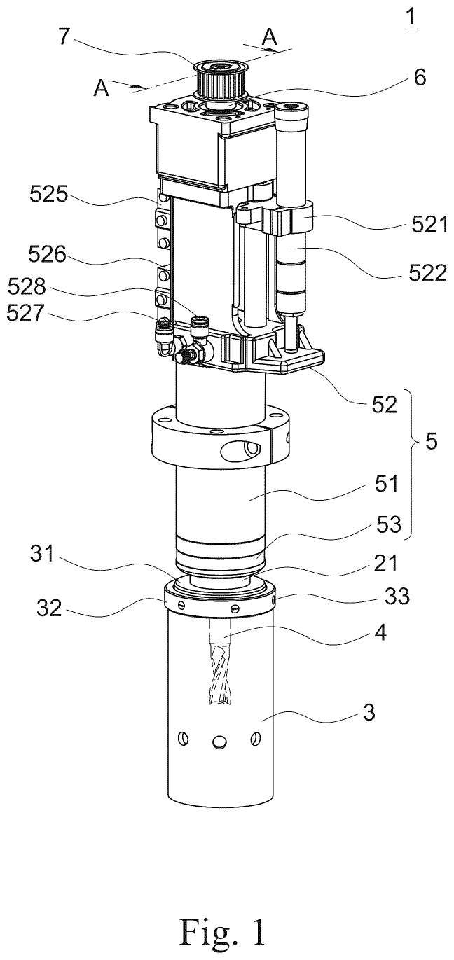

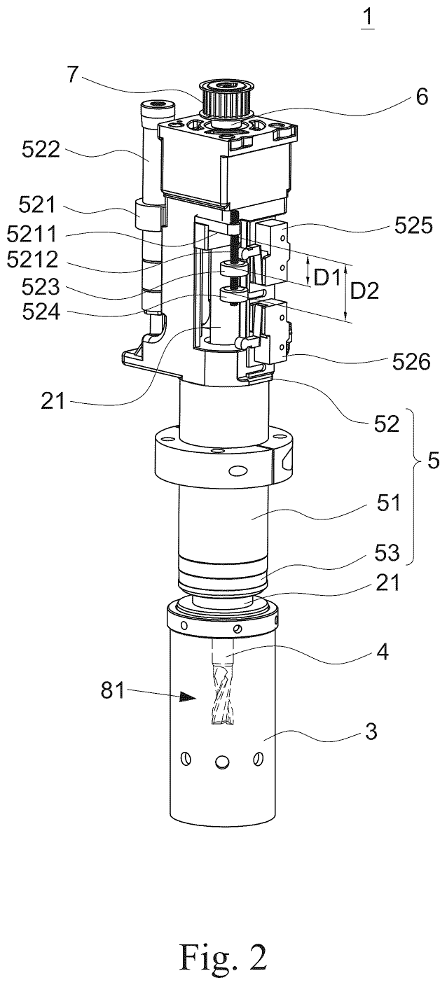

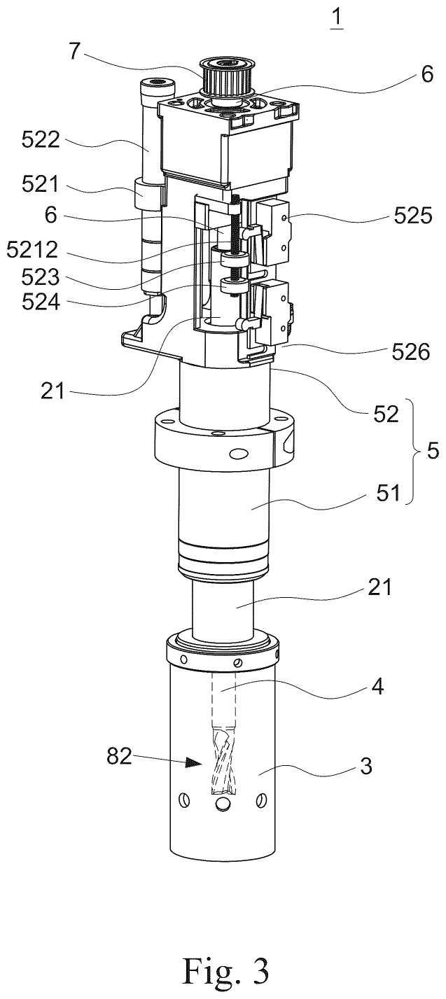

With reference to FIG. 1 to FIG. 4, which provide a first embodiment of the present invention. A milling device for grinding top pin machine is provided by the present invention, and has a cutter seat 2, a sleeve 3, a milling cutter 4, and a pedestal 5.

The tool holder 2 has a push rod 21 and a spindle 22, wherein the push rod 21 has a first accommodating space 211, and the spindle 22 is located in the first accommodating space 211.

The sleeve 3 is hollow and located at one end of the cutter seat 2. The upper end of the sleeve 3 is internally disposed a drill head fixed plate 31. The drill head fixed plate 31 is a hollow structure and located at the lower end of the push rod 21, and the drill head fixed plate 31 is connected to the push rod 21.

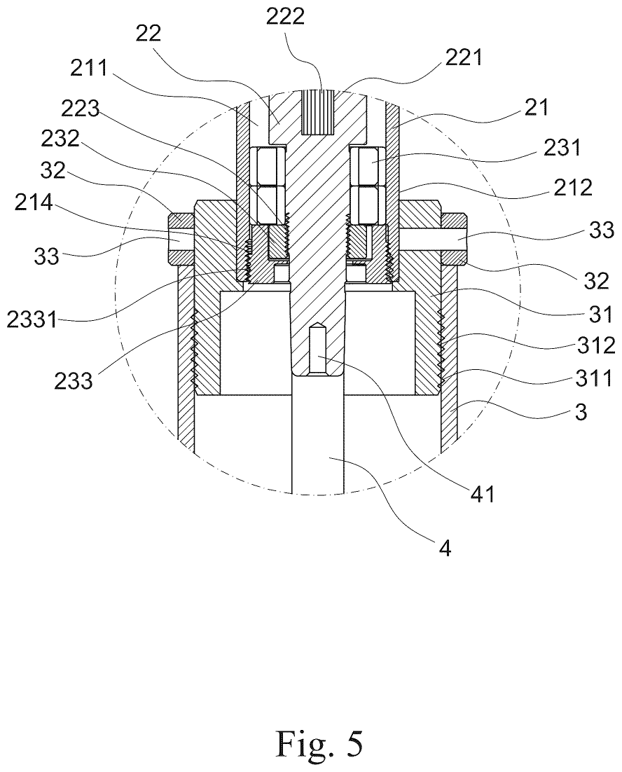

Please refer to FIG. 5, in addition, the drill head fixed plate 31 is preferably located at one side of the sleeve 3 in the first embodiment. The sleeve 3 contains an internal thread 311 which threads into an external thread 312 on the outer edge of the drill head fixed plate 31, in order to adjust the relative position between the sleeve 3 and the drill head fixed plate 31. This adjustment enables fine-tuning of the height position of the sleeve 3 as well.

The sleeve 3 additionally has a screw nut 32. Through a locking bolt 33, the sleeve 3 is fixed on the drill head fixed plate 31, and the drill head fixed plate 31 is firmly solidified on the push rod 21, so as to let the sleeve 3 and the push rod 21 move up and down simultaneously, if the adjustment of height position of the sleeve 3 is finished.

The milling cutter 4 is connected to the spindle 22, and is firmly locked in the screw hole at the bottom of the spindle 22 via a screw bolt 41. In addition, the milling cutter 4 is disposed in the sleeve 3.

The pedestal 5 has a collar 51, a stroke adjustment device 52, and a ball mill head 53. The collar 51 accommodates partial of the push rod 21, and the stroke adjustment device 52 is at the end of the collar 51.

The stroke adjustment device 52 is firmly connected to the end of the collar 51. On the other hand, the ball mill head 53 is fixed at the other end of the collar 51, in order to form an air cylinder.

A stroke bracket 521 is located at one side of the pedestal 5, and the stroke bracket 521 has an abutment surface 5211. Preferably, the abutment surface 5211 is located at one side of the stroke bracket 521.

A damper 522 is connected to the stroke bracket 521.

A first adjuster 523 is at a first distance DI from the abutment surface 5211.

A second adjuster 524 is at a second distance D2 from the abutment surface 5211.

A first stroke contactor 525 is adjacent to the first adjuster 523. When the first stroke contactor 525 contacts the first adjuster 523, the milling cutter 4 is in a first position 81.

A second stroke contactor 526 is adjacent to the second adjuster 524. When the second stroke contactor 526 contacts the second adjuster 524, the milling cutter 4 is in a second position 82.

The stroke bracket 521 further has a screw rod 5212. Preferably, the abutment surface 5211 is located at one side of the screw rod 5212. The first adjuster 523 and the second adjuster 524 are disposed at the screw rod 5212 respectively, and are able to adjust the positions on the screw rod 5212 individually.

For the preferred embodiment, the first adjuster 523 and the second adjuster 524 are both adjustment nuts, and both are disposed on the screw rod 5212. Besides, the first stroke contactor 525 and the second stroke contactor 526 are both micro-switch type stroke switches, and the first adjuster 523 and the second adjuster 524 are located between the first stroke contactor 525 and the second stroke contactor 526, but not limited thereto.

More, the two ends of the push rod 21 are a large-diameter section 212 and a small-diameter section 213 respectively, wherein the small-diameter section 213 is neighbor to the pedestal 5. The push rod 21 is hollow, so that the small-diameter section 213 can be in communication with the first accommodating space 211.

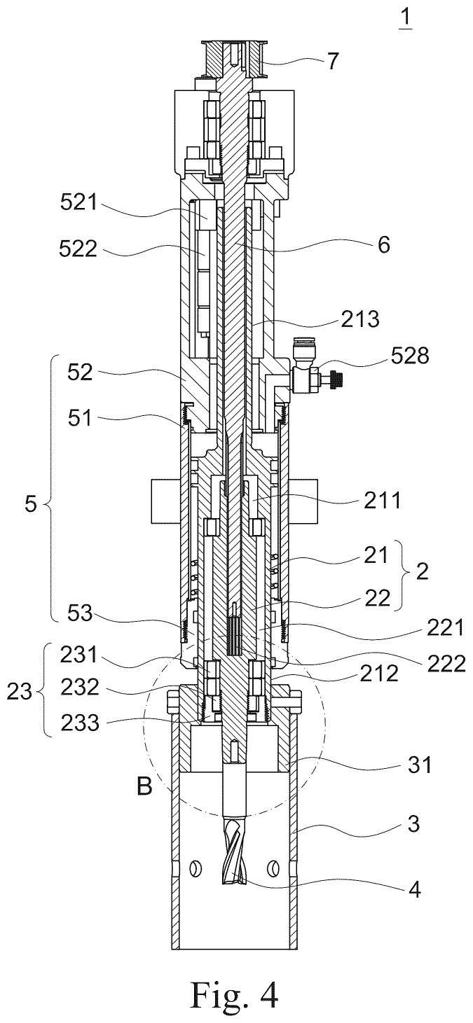

As to FIG. 4 and FIG. 5, The outer edge of the spindle 22 further has a limit device 23. The limit device 23 has a bearing 231, a locking nut 232, and a handle nut 233. The inner ring of the bearing 231 is tightly fitted onto the spindle 22, and the locking nut 232 is secured onto an outer thread 223 of the spindle 22 to support and fix on the bottom of the inner ring of the bearing 231, so as to let the locking nut 232 and the bearing 231 rotate together with the spindle 22. The handle nut 233 is in the large-diameter section 212 and accommodates the locking nut 232. The outer thread 2331 of the handle nut 233 is screwed into the internal thread 214 at one end of the push rod 21, in order to let the handle nut 233 be fixed on the bottom of the outer ring of the bearing 231.

For the first embodiment, there are two bearings 231 preferably, and the two parallel bearings are arranged to increase the stability of the spindle 22 and thereby improve cutting accuracy.

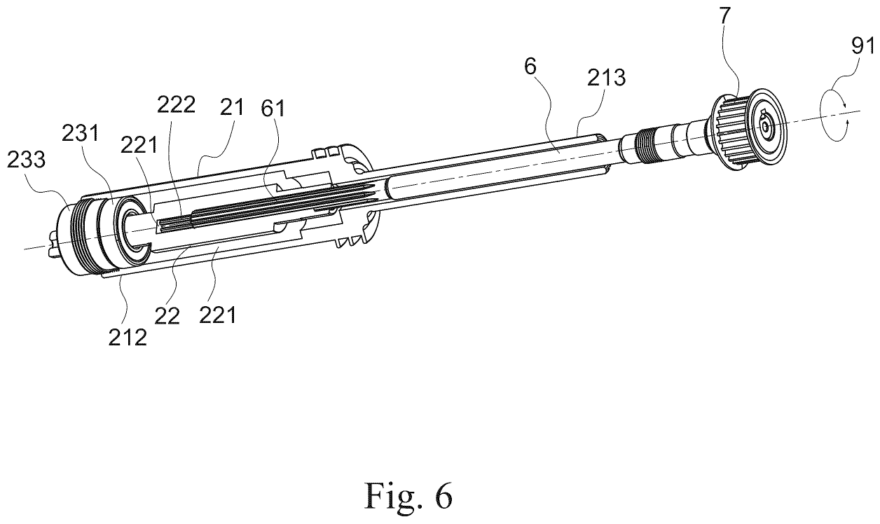

According to FIG. 6, the spindle 22 has a second accommodating space 221, which is able to contain a spline 6.

One end of the spline 6 has a first texture 61, and one end of the spindle 22 has a second texture 222, and the second accommodating space 221 has the second texture 222 corresponding to the first texture 61. Through the combination of the first texture 61 and the second texture 222, the spline 6 drives the spindle 22 for rotation movements 91, and the other end of the spline 6 is connected to a synchronous wheel 7, therefore the synchronous wheel 7 drives the spline 6 and the spindle 22 for synchronous rotations.

That is, for the embodiment, the first texture 61 contains plural external slots, and the second texture 222 contains plural internal slots corresponding to the first texture 61. The one end of the spline 6 is inserted into the second accommodating space 221. By means of the external slots and the internal slots that are corresponding to each other, the central axis of the spline 6 being a rotation axis is for the synchronous wheel 7 engaging in the rotation movements 91. Moreover, the spindle 22 can be moved up and down linearly by the first texture 61 and the second texture 222 as the external slots and the internal slots respectively.

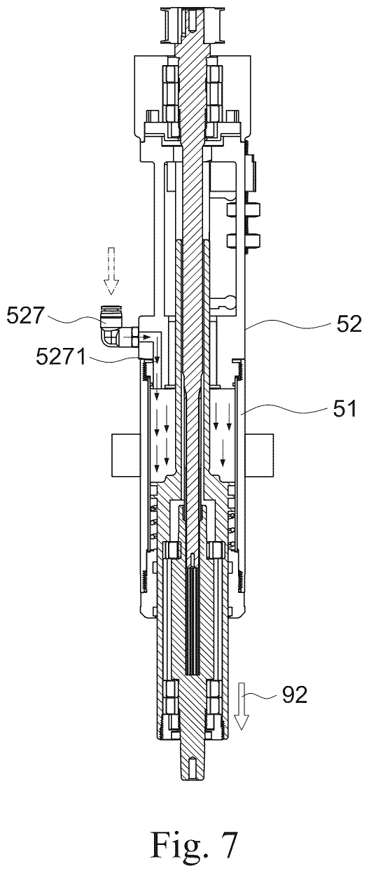

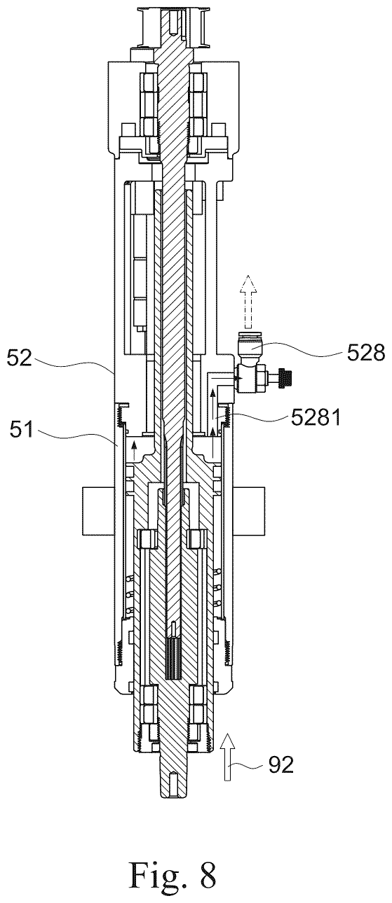

With respect to FIG. 7 and FIG. 8, for the first embodiment, the stroke adjustment device 52 is made of aluminum alloy, and has an air inlet flow channel 5271 and an air outlet flow channel 5281 internally. Besides, the stroke adjustment device 52 further has an air inlet valve 527 and an air outlet valve 528. The air inlet valve 527 provides a gas that enters the stroke adjustment device 52 from the air inlet flow channel 5271 and then reaches the collar 51, in order to let the push rod 21 perform a displacement movement 92. The air outlet valve 528 allows the gas to move out of the stroke adjustment device 52 from the air outlet flow channel 5281, so that the push rod 21 performs the displacement movement 92 and is reset, in order to facilitate replacement of the milling cutter 4.

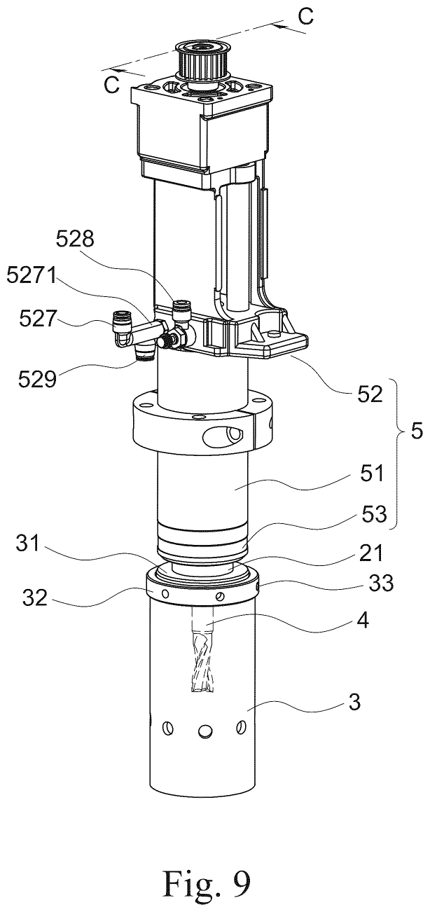

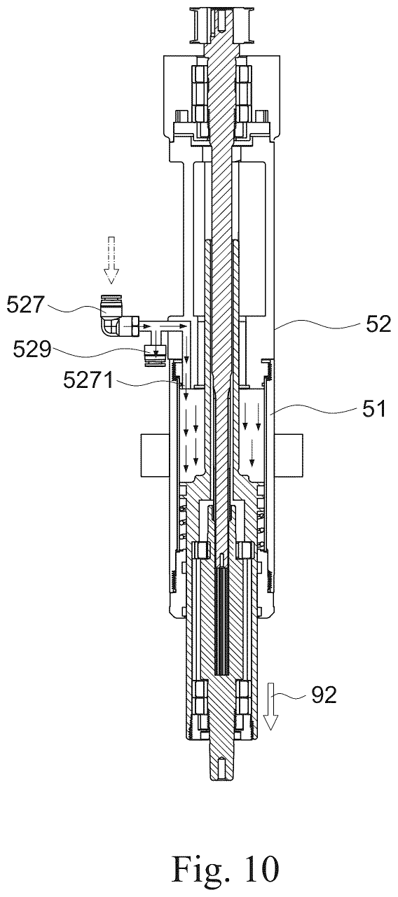

With regard to FIG. 9 and FIG. 10, which illustrate a second embodiment of the present invention. The differences between the first embodiment and the second embodiment are that of the pedestal 5 being without the damper 522, the first adjuster 523, the second adjuster 524, the first stroke contactor 525, and the second stroke contactor 526 for the second embodiment, others will be the same and may not be described any further hereinafter. Additionally, in this second embodiment, as shown in FIG. 10, an additional back pressure exhaust valve 529 connected to the back pressure exhaust valve, is installed at the air inlet flow channel 5271 connected to the air inlet valve 527, thus there are no needs for the damper 522, the first adjuster 523, the second adjuster 524, the first stroke contactor 525, and the second stroke contactor 526. When the back pressure exhaust pressure of the back pressure exhaust valve 529 is preset that is greater than the intake pressure (for example, setting the back pressure exhaust pressure of the back pressure exhaust valve 529 to be 6.9-7.5 kg per square centimeter, and the intake pressure to be 5-6.5 kg per square centimeter), if during operation, the intake pressure exceeds the back pressure exhaust pressure, the incoming gas will enter through the air inlet flow channel 5271 and be ejected via the back pressure exhaust valve 529. This prevents an excessive pressure from causing defects in the raised floor, and reduces vibration of the spindle 22, and lowers manufacturing costs.

As aforesaid, the advantages of the present invention are as following:
1. By means of arranging the plurality of milling devices into plural groups of milling device matrices in a non-interfering state, and combining with an automatic process, the top needle structures of the raised floors are ground and milled in batches, therefore it speeds up production and improves efficiency, and reduces labor requirements as well.
2. By way of the air inlet valve providing a gas to enter into the stroke adjustment device, the push rod performs a displacement movement. Further, through adjusting the positions of the first adjuster and the second adjuster on the screw rod individually, the milling cutter can then be moved for milling operations.

Although the present disclosure is disclosed in the foregoing embodiments, it is not intended to limit the present disclosure. Changes and modifications made without departing from the spirit and scope of the present disclosure belong to the scope of the claims of the present disclosure. The scope of protection of the present disclosure should be construed based on the following claims.

What is claimed is:

1. A milling device for a grinding ejector pin machine comprising:
a cutter seat (2), which has a push rod (21) and a spindle (22), wherein the push rod (21) has a first accommodating space (211), and the spindle (22) is located in the first accommodating space (211);
a sleeve (3), which is hollow and located at one end of the cutter seat (2);
a milling cutter (4), connected to the spindle (22) and located in the sleeve (3):
a pedestal (5), having a collar (51), a stroke adjustment device (52), and a ball mill head (53), the collar (51) accommodating partial of the push rod (21), the stroke adjustment device (52) is at one end of the collar (51).

2. The milling device for the grinding ejector pin machine according to claim 1, wherein the stroke adjustment device (52) further comprises:
a stroke bracket (521), which is located at one side of the pedestal (5) and has an abutment surface (5211);
a damper (522), which is connected to the stroke bracket (521);
a first adjuster (523), which is at a first distance (D1) from the abutment surface (5211);
a second adjuster (524), which is at a second distance (D2) from the abutment surface (5211);
a first stroke contactor (525), which is adjacent to the first adjuster (523), the milling cutter (4) being in a first position (81) when the first stroke contactor (525) contacts the first adjuster (523);
a second stroke contactor (526), which is adjacent to the second adjuster (524), the milling cutter (4) being in a second position (82) when the second stroke contactor (526) contacts the second adjuster (524).

3. The milling device for the grinding ejector pin machine according to claim 1, wherein an upper end of the sleeve (3) is internally disposed a drill head fixed plate (31), the head fixed plate (31) being a hollow structure and located at one end of the sleeve (3), the drill head fixed plate (31) being connected to a lower end of the push rod (21).

4. The milling device for the grinding ejector pin machine according to claim 1, wherein two ends of the push rod (21) are a large-diameter section (212) and a small-diameter section (213) respectively, the small-diameter section (213) being neighbor to the pedestal (5), the push rod (21) being hollow, so that the small-diameter section (213) can be in communication with the first accommodating space (211).

5. The milling device for the grinding ejector pin machine according to claim 4, wherein an outer edge of the spindle (22) further has a limit device (23) with a bearing (231), a locking nut (232), and a handle nut (233), the bearing (231) being fitted onto the spindle (22), the locking nut (232) being fixed on the bearing (231), the handle nut (233) being in the large-diameter section (212) and accommodating the locking nut (232), the handle nut (233) being screwed into an internal thread (214) of the push rod (21), in order to let the handle nut (233) be fixed on an outer ring of the bearing (231).

6. The milling device for the grinding ejector pin machine according to claim 1, wherein the spindle (22) has a second accommodating space (221) that accommodates a spline (6), one end of the spline (6) has a first texture (61), the second accommodating space (221) at one end of the spindle (22) having a second texture (222) corresponding to the first texture (61), through combination of the first texture (61) and the second texture (222), the spline (6) driving the spindle (22) for rotation movements (91).

7. The milling device for the grinding ejector pin machine according to claim 6, wherein another end of the spline (6) is connected to a synchronous wheel (7), the synchronous wheel (7) driving the spline (6) and the spindle (22) for synchronous rotations.

8. The milling device for the grinding ejector pin machine according to claim 1, wherein the stroke adjustment device (52) further has an air inlet valve (527) and an air outlet valve (528), the air inlet valve (527) providing a gas that enters into the stroke adjustment device (52) in order to let the push rod (21) perform a displacement movement (92), the air outlet valve (528) allowing the gas to move out of the stroke adjustment device (52), so as to facilitate replacement of the milling cutter (4).

9. The milling device for the grinding ejector pin machine according to claim 8, wherein the stroke adjustment device (52) further comprises a back pressure exhaust valve (529), which is at the air inlet flow channel (5271), the incoming gas being ejected via the back pressure exhaust valve (529) when the intake pressure exceeds the back pressure exhaust pressure.

10. The milling device for the grinding ejector pin machine according to claim 3, wherein the sleeve (3) has an internal thread (311) which threads into an external thread (312) on the outer edge of the drill head fixed plate (31), in order to adjust the relative position between the sleeve (3) and the drill head fixed plate (31).

11. The milling device for the grinding ejector pin machine according to claim 10 further comprising a locking bolt (33), via the locking bolt (33), the sleeve (3) being fixed on the drill head fixed plate (31), and the drill head fixed plate (31) being firmly solidified on the push rod (21), so as to let the sleeve (3) and the push rod (21) move up and down simultaneously.

12. The milling device for the grinding ejector pin machine according to claim 8, wherein the air inlet valve (527) provides the gas that enters the stroke adjustment device (52) from an air inlet flow channel (5271), in order to let the push rod (21) perform a displacement movement (92).

13. The milling device for the grinding ejector pin machine according to claim 8, wherein the air outlet valve (528) allows the gas to move out of the stroke adjustment device (52) from an air outlet flow channel (5281), so as to facilitate replacement of the milling cutter (4).

14. The milling device for the grinding ejector pin machine according to claim 10, wherein the sleeve (3) additionally has a screw nut (32), through a locking bolt (33), the sleeve (3) being fixed on the drill head fixed plate (31), and the drill head fixed plate (31) being firmly solidified on the push rod (21), so as to let the sleeve (3) and the push rod (21) move up and down simultaneously, if the adjustment of height position of the sleeve (3) is finished.

15. The milling device for the grinding ejector pin machine according to claim 1, wherein the milling cutter (4) is firmly locked in a screw hole at a bottom of the spindle (22) via a screw bolt (41), the milling cutter (4) being disposed in the sleeve (3).

16. The milling device for the grinding ejector pin machine according to claim 1, wherein the stroke adjustment device (52) is firmly connected to one end of the collar (51), the ball mill head (53) being fixed at another end of the collar (51), in order to form an air cylinder.

17. The milling device for the grinding ejector pin machine according to claim 1, wherein the abutment surface (5211) is located at one side of the stroke bracket (521).

18. The milling device for the grinding ejector pin machine according to claim 6, wherein the first texture (61) has plural external slots, and the second texture (222) has plural internal slots corresponding to the first texture (61), the one end of the spline (6) being inserted into the second accommodating space (221), by means of the external slots and the internal slots that are corresponding to each other, the spindle (22) being moved up and down linearly.

19. The milling device for the grinding ejector pin machine according to claim 5, wherein the bearing (231) is fitted onto the spindle (22) and the locking nut (232) is fixed on the bearing (231), that is, the inner ring of the bearing (231) being tightly fitted onto the spindle (22), and the locking nut (232) being secured onto an outer thread (223) of the spindle (22) to support and fix on the bottom of the inner ring of the bearing (231), so as to let the locking nut (232) and the bearing (231) rotate together with the spindle (22).

20. The milling device for the grinding ejector pin machine according to claim 5, wherein the handle nut (233) accommodates the locking nut (232), and the handle nut (233) is screwed into an internal thread (214) of the push rod (21), in order to let the handle nut (233) be fixed on an outer ring of the bearing (231), that is, an outer thread (2331) of the handle nut (233) being screwed into the internal thread (214) at one end of the push rod (21), in order to let the handle nut (233) be fixed on a bottom of the outer ring of the bearing (231).
